(19) United States
(12) Patent Application Publication
(10) Pub. No.: US 2019/0232864 A1
(43) Pub. Date: Aug. 1, 2019

(54) DISPLAY DEVICE AND MOUNTING STRUCTURE OF VEHICLE METER

(71) Applicant: HONDA MOTOR CO., LTD., Tokyo (JP)

(72) Inventor: Hayato Kawakami, Wako-shi (JP)

(21) Appl. No.: 16/251,145

(22) Filed: Jan. 18, 2019

(30) Foreign Application Priority Data
Jan. 26, 2018 (JP) 2018-012046

(51) Int. Cl. B60Q 3/18; B60Q 3/14; G01D 11/28

(52) U.S. Cl. CPC B60Q 3/18; G01D 11/28; B60Q 3/14

(57) ABSTRACT

There is provided a display device (1) including a display (30), a protective member (40) which covers at least a part of the display and is formed of a member different from a display surface of the display, and a light detector (50) which is provided in contact with or in proximity to the protective member and is configured to detect an amount of light guided by the protective member.

### CROSS-REFERENCE TO RELATED APPLICATION

Priority is claimed on Japanese Patent Application No. 2018-012046, filed Jan. 26, 2018, the content of which is incorporated herein by reference.

### BACKGROUND

### Field of the Invention

The present invention relates to a display device and a mounting structure of a vehicle meter.

### Description of Related Art

Conventionally, a technique for displaying an image of a vehicle meter on a display instead of a mechanical vehicle meter is known (for example, Japanese Unexamined Patent Application, First Publication No. 2017-149182). Further, a technique in which a hole is provided in a vehicle meter, light passing through the hole is detected, and luminance of a display used instead of the vehicle meter is adjusted on the basis of a detected light amount is known (for example, Japanese Unexamined Patent Application, First Publication No. 2006-329711).

### SUMMARY

A display (a display device) that shows a user an image by emitting light looks different according to the amount of external light. For example, in the case in which the amount of external light is large, for example, a case in which direct sunlight is incident, it is difficult to see an image when luminance of the display device is low. In the technique described in Patent Document 1, it was impossible to adjust the luminance of the display according to the amount of irradiated light. Further, in the technique described in Patent Document 2, since the hole is provided at a position which is visible to a driver, an exterior of the vehicle meter may be impaired. An aspect of the present invention have been made in view of the above-described problems, and it is an object of the present invention to provide a display device and a mounting structure of a vehicle meter capable of appropriately detecting an amount of irradiated light while maintaining the design of the device itself.

The display device and the mounting structure of a vehicle meter according to the present invention employ the following constitution.

(1): A display device according to one aspect of the present invention is a display device including a display, a protective member which covers at least a part of the display and is formed of a member different from a display surface of the display, and a light detector which is provided in contact with or in proximity to the protective member and is configured to detect an amount of light guided by the protective member.

(2): In the aspect of (1), the display may display an image recognized as a vehicle meter.

(3): In the aspect of (1) or (2), the display device may further include a luminance controller which is configured to change a luminance of the display on the basis of a detection result of the light detector.

(4): In the aspects of (1) to (3), the display may be mounted together with a mechanical display mechanism.

(5): In the aspects of (1) to (3), the display may include a mechanical display mechanism and display a physical quantity relating to a traveling state of a vehicle.

(6): In the aspects of (1) to (3), the display device may further include an illuminator which is configured to illuminate the display, and an illumination controller which is configured to change a luminance of the illuminator on the basis of a detection result of the light detector.

(7): In the aspect of (6), the display device may further include a difference acquirer configured to acquire value obtained by subtracting at least one of an amount of light radiated by the display and an amount of light radiated by the illuminator from the detection result detected by the light detector as an amount of external light.

(8): In the aspects of (1) to (7), the protective member may have a structure in which a surface portion covering at least a part of a display surface of the display and an extending portion extending from an outer edge of the surface portion and attached to a support member are integrally formed, and the light detector may be provided in contact with or in proximity to the extending portion.

(9): In the aspects of (1) to (8), the light detector may be provided at a lower end of the protective member.

(10): A vehicle meter according to present invention is a mounting structure of a vehicle meter, wherein a protective member formed of a member different from a display surface of a display configured to display an image recognized as a vehicle meter is mounted to a support member to cover at least a part of the display, and a light detector configured to detect an amount of light guided by the protective member is provided in contact with or in proximity to a lower end of the protective member.

According to the aspects of (1) to (100), the amount of irradiated light can be appropriately detected.

According to the aspect of (3) or (6), it is possible to change the luminance of the display according to light in the surrounding environment of the vehicle so that the display can be adjusted to be easily seen by a driver.

According to the aspect of (4), the difficulty in viewing of the display is emphasized by being installed together with the mechanical display mechanism, but this can be alleviated.

According to the aspect of (9), it is possible to make the light detector hard for a user to see and to improve a design thereof.

According to the aspect of (10), a vehicle meter which can maintain high visibility can be provided.

### BRIEF DESCRIPTION OF THE DRAWINGS

FIG. 1 is a front view of a display device according to a first embodiment.

FIG. 2 is a perspective view of the display device according to the first embodiment.

FIG. 3 is a cross-sectional view taken along line A-A′ in FIG. 1.

FIG. 4 is a diagram showing an example of a functional constitution of a controller of the display device of the first embodiment.

FIG. 5 is a diagram showing an example of light amount luminance correspondence information of the first embodiment.

FIG. 6 is a diagram showing an example of a detection result by a light detector of the first embodiment.

FIG. 7 is a flowchart showing an example of processing of the controller according to the first embodiment.

FIG. 8 is a diagram showing an example of a functional constitution of a controller of the display device according to a modified example.

FIG. 9 is a flowchart showing an example of processing of the controller according to the modified example.

FIG. 10 is a front view of a display device according to a second embodiment.

FIG. 11 is a diagram showing an example of a functional constitution of a controller of the display device according to the second embodiment.

FIG. 12 is a flowchart showing an example of processing of the controller according to the second embodiment.

### DESCRIPTION OF EMBODIMENTS

### First Embodiment

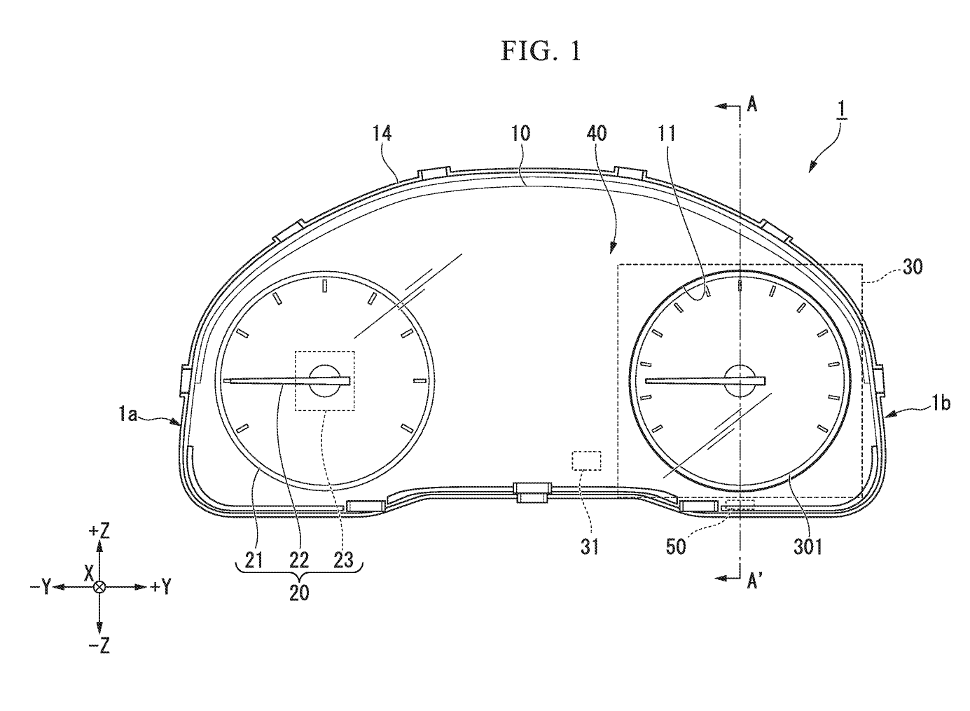

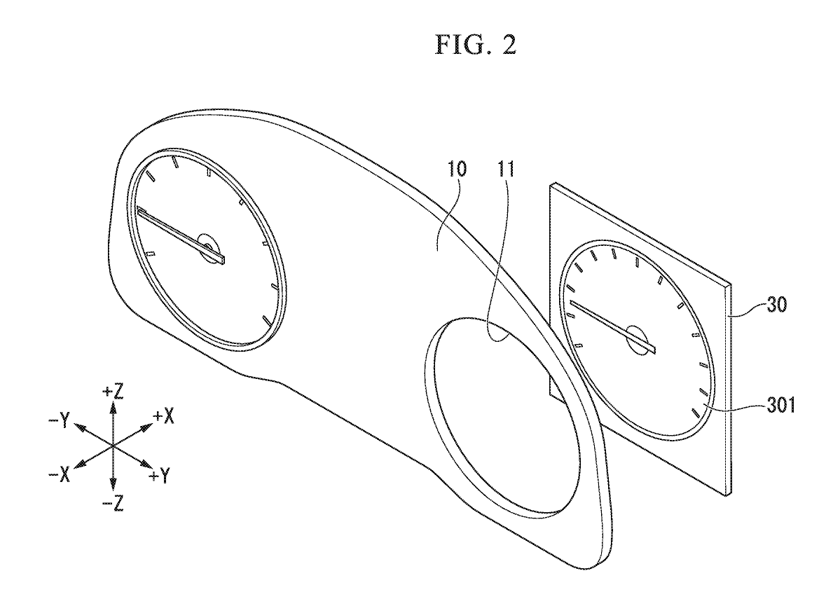

Hereinafter, a first embodiment of the present invention will be described with reference to the drawings. FIG. 1 is a front view of a display device 1 according to a first embodiment. FIG. 2 is a perspective view of the display device 1 according to the first embodiment. The display device 1 is a device which adjusts luminance of a display surface according to an amount of light radiated on the display surface. In the following embodiment, the display device 1 is mounted in a vehicle, displays information on the vehicle and provides the information to a driver, but the present invention is not limited thereto, and the display device 1 may be used for other purposes. For example, the other purposes include displaying of a navigation device mounted in a vehicle, displaying of an audio device, displaying of a display device confirmed by an occupant riding in a rear seat, and so on.

The display device 1 includes, for example, a display plate 10, an analog meter 20, a display panel 30, a cover 40, and a light detector 50.

Here, a X direction, a Y direction, and a Z direction will be defined. The Y direction and the Z direction are directions along the display surface of the display panel 30. The Z direction is a direction orthogonal to the Y direction.

A positive Z direction is an upward direction in FIG. 1 in a positive Y direction. The positive Z direction is also referred to as “up” or “upward.” A negative Z direction is a direction opposite to the positive Z direction. The negative Z direction is referred to as “down” or “downward.” In cases in which the positive Z direction and the negative Z direction are not distinguished from each other, they are referred to as the “Z direction” or “vertical direction.” The X direction is a direction orthogonal to the Y direction and the Z direction and is a direction which is slightly downward from a traveling direction of the vehicle.

The display panel 30 displays an image. The display panel 30 is realized by, for example, a liquid crystal display panel, a plasma display panel, an organic electro luminescence (EL) display panel, or the like. The display panel 30 is provided on the right side of the display device 1 as seen by a driver. An image showing information on a vehicle in which the display device 1 is mounted (hereinafter, referred to as vehicle information), such as that displayed on a vehicle meter, is displayed on the display panel 30. The vehicle information is, for example, state information which indicates a state of the vehicle, traveling information on a traveling state of the vehicle, environment information on an environment in which the vehicle travels, and so on. The state information is information indicating, for example, the remaining amount of fuel, the water temperature in a radiator, the lighting state of a headlight, and so on. The traveling information is, for example, information indicating the speed of the vehicle, and the number of revolutions of an engine. The environmental information is information indicating, for example, a statutory speed determined for a road on which the vehicle travels, and an outside air temperature and the weather. The display panel 30 includes, for example, a controller 31. The controller 31 generates an image signal for displaying an image indicating the vehicle information on the display panel 30. The image signal is output from the controller 31 to the display panel 30. The display panel 30 displays the image indicating the vehicle information according to the image signal.

The analog meter 20 indicates the vehicle information and provides it to the driver. The vehicle information indicated by the analog meter 20 is, for example, the state information indicating the state of the vehicle, the traveling information on the traveling state of the vehicle, the environmental information on the environment in which the vehicle travels, and so on. The analog meter 20 is provided on the left side of the display panel 30 as seen by the driver. The analog meter 20 includes, for example, a ring 21, a pointing needle 22, and a actuator 23. The pointing needle 22 is rotated by the actuator 23 within a region surrounded by the ring 21. Indicators (for example, scale marks or numerals) indicating physical quantity relating to the traveling state of the vehicle on which the display device 1 is mounted are displayed in the region surrounded by the ring 21.

As an example, on the display panel 30, an image indicating the number of revolutions of the engine is displayed in a partial region (an image display region 301 shown in the drawing) of the display surface of the display panel 30. An image indicating the number of revolutions of the engine is an example of an image recognized as the vehicle meter. The speed of the vehicle is indicated in the analog meter 20. Specifically, the actuator 23 rotates the pointing needle 22 on the basis of an input from a sensor which detects the speed of the vehicle. The scale marks indicating the speed of the vehicle are attached to the analog meter 20, and the speed of the vehicle is indicated by a position of the pointing needle 22 with respect to the scale marks. The analog meter 20 is an example of a mechanical display mechanism. The display panel 30 may be provided on the left side as seen by the driver, and the analog meter 20 may be provided on the right side as seen by the driver. The display device 1 may have a constitution in which the display panel 30 is disposed at a center thereof.

The display plate 10 is a member which supports the display panel 30 and the analog meter 20 and allows the driver to visually recognize a part of the display panel 30. The display plate 10 has a hole 11 passing therethrough in the X direction. The hole 11 makes a part of the display panel 30 visible to the driver. In this case, the portion which is visually recognized through the hole 11 is the image display region 301. Therefore, the display plate 10 shields a part of the display panel 30. The display plate 10 includes, for example, a flat surface (hereinafter, referred to as a first surface 10a) and a flat back surface (hereinafter, referred to as a second surface 10b). Among the surfaces of the display plate 10, the first surface 10a is a surface on the side of the driver. The second surface 10b is a surface on the side of the display panel 30. The analog meter 20 is provided on the first surface 10a. For example, an adhesive is applied to the second surface 10b, and the display plate 10 is bonded to a region of the display panel 30 other than the image display region 301. The display panel 30 may be fixed to the display plate 10 by screwing, caulking, welding or the like.

The display panel 30 may have a shape which coincides with a shape of the hole 11 (in the shown example, a round shape). The display plate 10 may have a constitution in which a member having high light transmittance is fitted in the hole 11. In this case, the portion visually recognized through the member having the high light transmittance is the image display region 301.

A bezel 12 is a casing which defines a space in which the display plate 10, the analog meter 20, the display panel 30, and the light detector 50 are accommodated.

The cover 40 closes an opening of the bezel 12. The display plate 10, the analog meter 20, the display panel 30 and the light detector 50 are supported by the bezel 12 or the respective parts supported by the bezel 12 and are disposed between the bezel 12 and the cover 40. The bezel 12 is an example of a support member. The cover 40 is an example of a protective member.

The cover 40 is formed entirely of, for example, a nearly transparent material. Therefore, the light of the image displayed by the display panel 30 passes through the hole 11, reaches the cover 40 and then can enter eyes of the driver. The cover 40 may be subjected to an optical treatment for suppressing reflection. In this case, the driver can visually recognize the image displayed by the display panel 30 well without being hindered by the reflection on the cover 40.

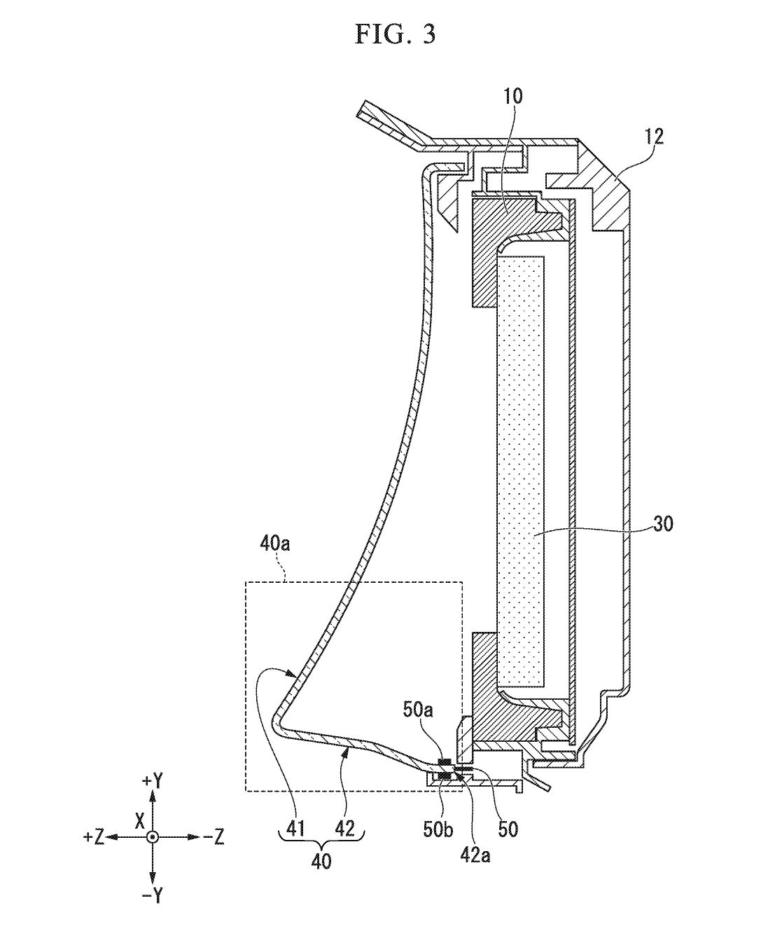

FIG. 3 is a cross-sectional view taken along line A-A′ in FIG. 1. The line A-A′ is a line passing through a center of the hole 11 (the image display region 301) and is a line parallel to the Z direction. As shown in FIG. 3, the cover 40 covers the display plate 10, the analog meter 20 and the display panel 30. A surface portion 41 and a curved portion 42 are provided on the cover 40. For example, the surface portion 41 is curved so that a center portion thereof is convex toward the display plate 10. Specifically, a surface of the surface portion 41 is recessed in the positive X direction, and a back surface of the surface portion 41 bulges in the positive X direction. The curved portion 42 extends from an outer circumferential edge of the surface portion 41 in a direction of the bezel 12. The curbed portion 42 is fixed to the bezel 12. The cover 40 can suppress the light radiated on the cover 40 from being reflected by the surface portion 41 being curved, thereby preventing the driver from being hindered in the visibility of the display of the display device 1. In the above description, the case in which the surface portion 41 is curved has been described, but the present invention is not limited thereto. The surface portion 41 may be curved so that the center portion thereof is concave toward the display plate 10, or it may be curved with another curvature. The surface portion 41 may not be curved but may be flat.

As shown in FIG. 2, the display plate 10 is fixed to and supported by the bezel 12. As described above, the display panel 30 is bonded and fixed to the second surface 10b by an adhesive applied to the second surface 10b of the display plate 10. Accordingly, the display panel 30 is fixed to and supported by the display plate 10 fixed to the bezel 12.

The bezel 12 may include a support portion for supporting the display panel 30, and the display panel 30 may be supported by the bezel 12 due to the support portion of the bezel 12. In this case, the display panel 30 may not be attached to the second surface 10b of the display plate 10.

As shown in FIG. 2, the light detector 50 is provided at a tip end of the curved portion 42 of the cover 40 to be in contact with or in proximity to the curved portion 42.

Proximity means that they face each other at an interval of, for example, a few [mm]. The light detector 50 detects an amount of light which is radiated on the cover 40 and guided by the cover 40. Light guiding means that light propagates through the interior formed by a thickness of the cover 40 while being reflected by the surface of the cover 40. The light radiated on the cover 40 is, for example, external light that enters from a window glass of the vehicle or light diffusely reflected in a vehicle interior. Therefore, the light detector 50 detects the amount of external light that enters from a window glass of a driver's seat or the amount of light diffusely reflected in the vehicle interior. In the following description, a case in which the light detector 50 comes into contact with an end surface (hereinafter, an end surface 42a) of the curved portion 42 will be described.

In the above description, the case in which the cover 40 is formed entirely of a nearly transparent material has been described, but the present invention is not limited thereto. The cover 40 may be formed of a smoke material or the like as long as it can guide light.

Here, it is preferable that the light detector 50 be provided at a position in which it is difficult for the driver to visually recognize it. The position in which it is difficult for the driver to visually recognize it is, for example, a lower end (hereinafter, a lower end 40a) of the cover 40. The lower end 40a is at least a part of the curved portion 42, more preferably a portion located within a few [cm] from the end surface 42a.

In the above description, the case in which the light detector 50 is provided at a position facing the end surface 42a has been described, but the present invention is not limited thereto. The light detector 50 may be provided at a position other than the position facing the end surface 42a as long as it is the lower end 40a. The light detector 50 may be provided, for example, at a position inside the curved portion 42 (a position of the light detector 50a shown in the drawing) or at a position outside the curved portion 42 (a position of a light detector 50b shown in the drawing).

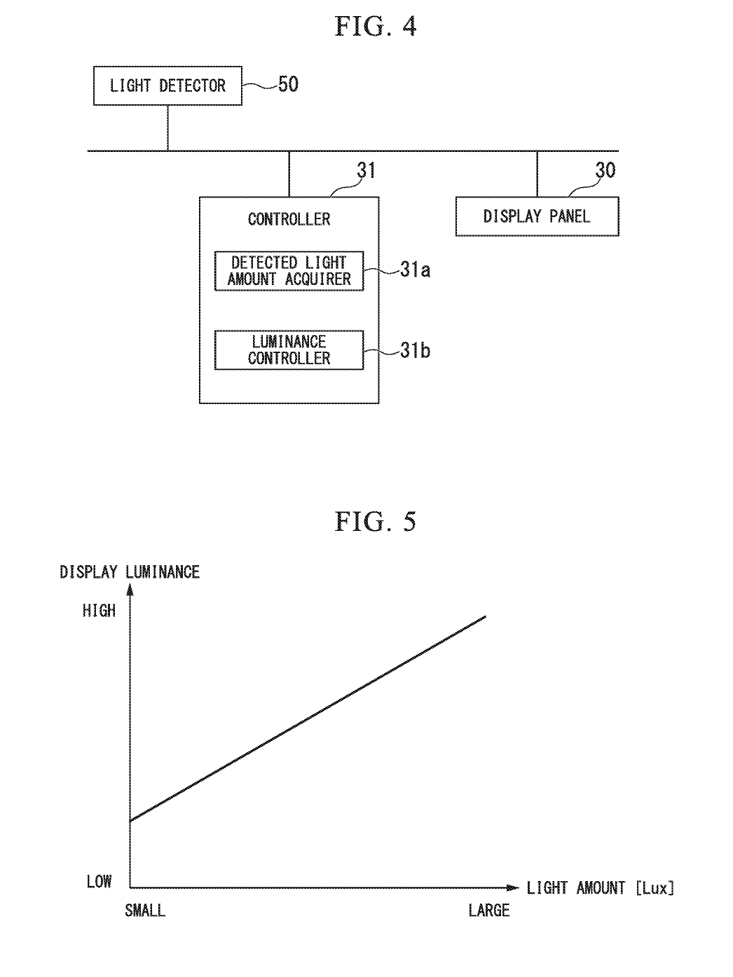

FIG. 4 is a diagram showing an example of a functional constitution of the controller 31 of the display device 1 according to the first embodiment. The controller 31 controls the luminance of the display panel 30 on the basis of the amount of light detected by the light detector 50. The controller 31 is realized by a hardware processor such as a central processing unit (CPU) executing a program (software). The controller 31 includes, for example, a detected light amount acquirer 31a and a luminance controller 31b as functional units thereof. Some or all of these constituent elements (excluding a built-in memory part) may be realized by hardware (including a circuit portion; including circuitry) such as a large scale integration (LSI), an application specific integrated circuit (ASIC), a field-programmable gate array (FPGA), or a graphics processing unit (GPU), or may be realized by software and hardware in cooperation.

The controller 31, the display panel 30 and the light detector 50 are connected via a dedicated communication line or an internal bus so that information can be transmitted and received. The detected light amount acquirer 31a acquires information indicating the amount of light detected by the light detector 50. The luminance controller 31b controls the luminance of the display panel 30. The controller 31 controls the luminance of the display panel 30 on the basis of, for example, light amount luminance correspondence information and a detection result of the light detector 50. The light amount luminance correspondence information is information in which the amount of light detected by the light detector 50 is associated with the luminance (that is, a display luminance) of the display panel 30.

FIG. 5 is a diagram showing an example of the light amount luminance correspondence information of the first embodiment. The light amount luminance correspondence information is associated with high luminance when the detection result of the light detector 50 indicates that the mount of light is large (that is, the surroundings of the display device 1 are bright) and is associated with low luminance when the detection result of the light detector 50 indicates that the amount of light is small (that is, the surroundings of the display device 1 are dark). Therefore, the controller 31 increases the luminance of the display panel 30 when the surroundings of the display device 1 are bright and decreases the luminance of the display panel 30 when the surroundings of the display device 1 are dark. The controller 31 may be constituted to control the display panel 30 to a predetermined luminance even when the detection result of the light detector 50 indicates that light is not detected. The predetermined luminance is a luminance at which the driver can visually recognize display content of the display panel 30 even when the surroundings of the display device 1 are dark.

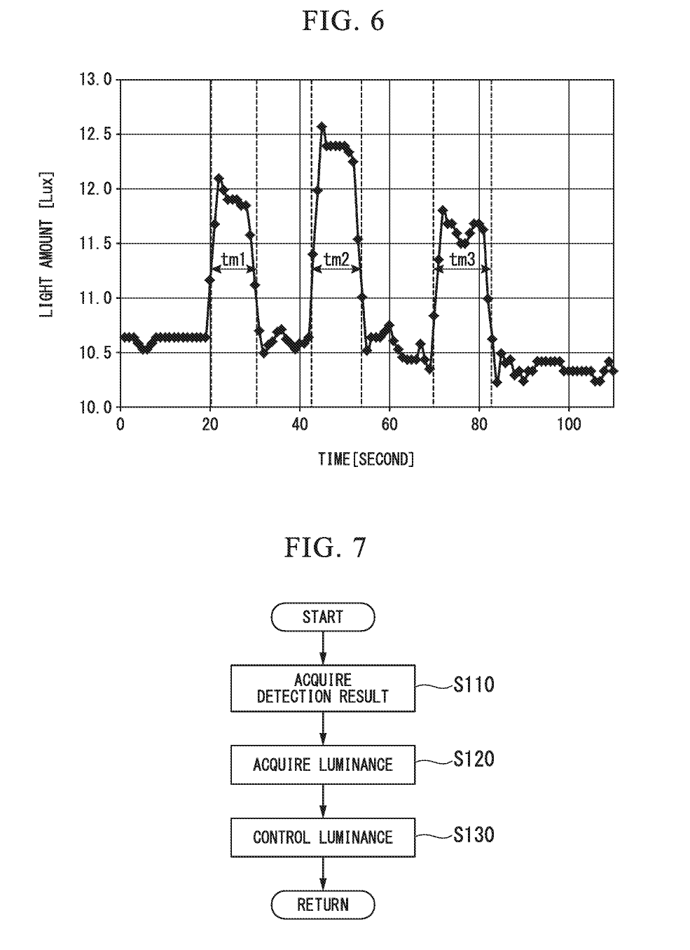

FIG. 6 is a diagram showing an example of the detection result by the light detector 50 of the first embodiment. Light is radiated on the display device 1 by a light emitting diode (LED) light or the like. Specifically, the display device 1 is irradiated with light for about 10 seconds (a period tm1 shown in the drawing) after 20 seconds have elapsed from start of the detection of the amount of light by the light detector 50, for about 10 seconds (a period tm2 shown in the drawing) after 42 seconds have elapsed and for about 10 seconds (a period tm3 shown in the drawing) after 58 seconds have elapsed. As shown in FIG. 6, the light detector 50 of the display device 1 can detect the light which is radiated and guided to the cover 40 in any period tm.

FIG. 7 is a flowchart showing an example of processing of the controller 31 according to the first embodiment. The processing of this flowchart is repeated, for example. The detected light amount acquirer 31a acquires the detection result of the light detector 50 which detects the amount of light (Step S110). The luminance controller 31b acquires the luminance of the display panel 30 on the basis of the detection result and the light amount luminance correspondence information (Step S120). The luminance controller 31b controls the luminance of the display panel 30 on the basis of the acquired luminance (Step S130).

### Summary of First Embodiment

As described above, the display device 1 of the embodiment includes the display (the display panel 30), the protective member (the cover 40) which covers at least a part of the display and is formed of a member different from the display surface of the display panel 30, and the light detector 50 which is provided in contact with or in proximity to the cover 40 and detects the amount of light guided by the cover 40. Here, in the constitution in which the light detector 50 detects light at a pinpoint, it may be difficult to accurately detect the amount of ambient light even when the amount of the ambient light is large (bright), like a case in which the light detector 50 is shadowed. In the display device 1 of the embodiment, the light detector 50 detects light which is radiated on the surface portion 41 of the cover 40 and guided by the cover 40. Therefore, the light detector 50 of the display device 1 according to the embodiment can detect the light radiated on the cover 40 in a planar manner by the surface portion 41 and can detect the amount of ambient light more accurately.

The display panel 30 of the display device 1 of the embodiment displays an image (in this example, an image indicating the number of revolutions of an engine) which is recognized as a vehicle meter. Here, the surrounding environment of the vehicle changes sequentially according to movement of the vehicle. According to the display device 1 of the embodiment, it is possible to detect the light in the surrounding environment of the vehicle which changes sequentially.

The display device 1 of the embodiment further includes the controller 31 which changes the luminance of the display panel 30 on the basis of the detection result of the light detector 50. According to the display device 1 of the embodiment, it is possible to change the luminance of the display panel 30 according to the light in the surrounding environment of the vehicle which changes sequentially and to adjust the display so that the display can be easily seen by the driver.

The display panel 30 of the display device 1 of the embodiment is mounted together with a mechanical display mechanism (the analog meter 20). Here, the reflectance of light may be different between the analog meter 20 and the display panel 30. Specifically, in the analog meter 20 and the display panel 30, the display panel 30 has higher reflectance of light. From the viewpoint of ease of visual recognition by the driver, it is preferable that the luminance of the display panel 30 be adjusted to approximately the same level as the luminance of the display device 1 (the analog meter 20). According to the display device 1 of the embodiment, even when the analog meter 20 and the display panel 30 which respectively have different reflectance are mounted together, it is possible to appropriately control the luminance of the display panel 30, that is, to alleviate the difficulty in viewing the display panel 30 emphasized by being mounted together with the analog meter 20.

The cover 40 of the display device 1 of the embodiment has a structure in which the surface portion 41 covering at least a part of the display surface of the display panel 30 and an extending portion (in this example, the curved portion 42) extending from an outer edge of the surface portion 41 and attached to the support member (the bezel 12) are formed integrally, and the light detector 50 is provided in contact with or in proximity to the curved portion 42. The light detector 50 of the display device 1 of the embodiment is provided at the lower end 40a of the cover 40. Therefore, the light detector 50 of the display device 1 of the embodiment can detect the light which is radiated on the cover 40 and guided to the curved portion 42. According to the display device 1 of the embodiment, it is possible to improve an exterior, that is, a design of the display device 1 by providing the light detector 50 at a position of the cover 40 in which it is hard for the driver to see. As long as the cover 40 can guide the light to the light detector 50, the bezel 12 and the curved portion 42 may be constituted separately.

In the above description, the case in which the display device 1 includes the display plate 10, the analog meter 20 and the display panel 30, but the present invention is not limited thereto. For example, the display device 1 may not include the display plate 10 and the analog meter 20 but may be entirely constituted by the display panel 30. In this case, the vehicle information indicated by the analog meter 20 is also indicated by the image displayed on the display panel 30.

### Modified Example

Hereinafter, a modified example according to the first embodiment will be described. Here, on the detection result of the light detector 50, the amount of light (hereinafter referred to as image light) which is radiated when the display panel 30 displays the image is superimposed. In the modified example, a case in which the luminance controller 31b controls the luminance of the display panel 30 on the further basis of the image light will be described. Constituent elements similar to those of the above-described embodiment are designated by the same reference numerals, and descriptions thereof will be omitted.

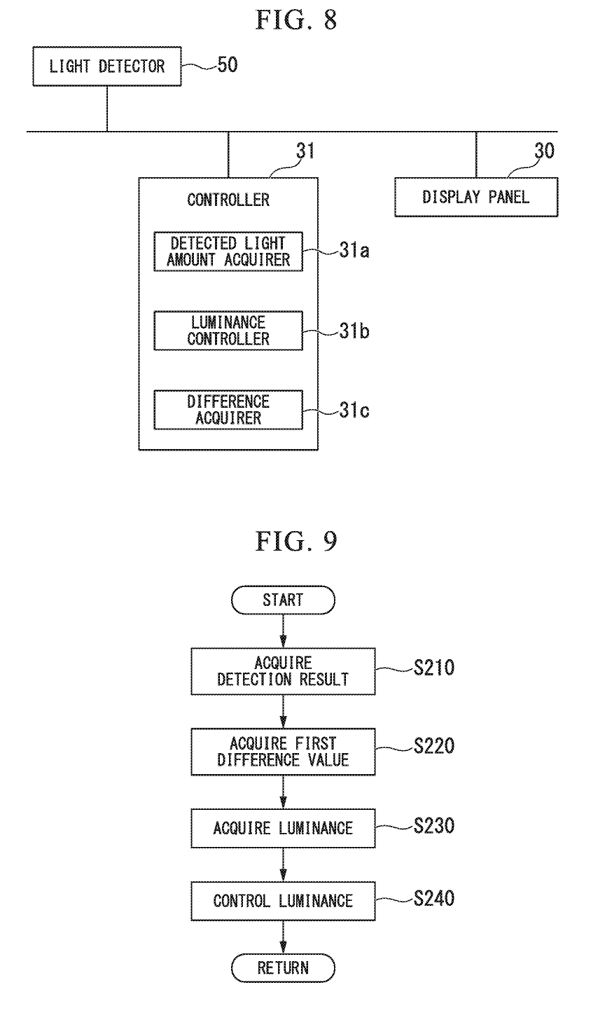

FIG. 8 is a diagram showing an example of a functional constitution of the controller 31 of the display device 1 according to a modified example. The controller 31 according to the modified example includes, for example, a detected light amount acquirer 31a, a luminance controller 31b and a difference acquirer 31cas functional units thereof. The difference acquirer 31c acquires a value obtained by subtracting the amount of image light from the detection result detected by the light detector 50. Specifically, the difference acquirer 31c acquires information indicating the detection result detected by the light detector 50 from the detected light amount acquirer 31a, acquires the information indicating the luminance of the display panel 30, that is, the amount of image light from the luminance controller 31b, and then acquires a value (hereinafter referred to as a first difference value) obtained by subtracting the amount of image light from the amount of light detected by the light detector 50.

The luminance controller 31b changes the luminance of the display panel 30 on the basis of the first difference value acquired by the difference acquirer 31cand the light amount luminance correspondence information. In this case, the light amount luminance correspondence information is information in which the first difference value is associated with the luminance (that is, the display luminance) of the display panel 30. Specifically, when the first difference value acquired by the difference acquirer 31c indicates that the amount of light is great (that is, the surroundings of the display device 1 are bright), the light amount luminance correspondence information is associated with high luminance, and when the first difference value acquired by the difference acquirer 31cindicates that the amount of light is small (that is, the surroundings of the display device 1 are dark), the light amount luminance correspondence information is associated with low luminance.

FIG. 9 is a flowchart showing an example of processing of the controller 31 according to the modified example. The processing of this flowchart is repeated, for example. The detected light amount acquirer 31a acquires the detection result in which the light detector 50 detects the amount of light (Step S210). The difference acquirer 31cacquires the first difference value on the basis of the light amount detected by the light detector 50 and the amount of image light of the display panel 30 (Step S220). The luminance controller 31b acquires the luminance of the display panel 30 on the basis of the first difference value and the light amount luminance correspondence information (Step S230). The luminance controller 31b controls the luminance of the display panel 30 on the basis of the acquired luminance (Step S240).

### Summary of Modified Example

As described above, in the display device 1 of the modified example, the luminance controller 31b changes the luminance of the display panel 30 on the basis of the value which is acquired by the difference acquirer 31cand is the value (the first difference value in an example) obtained by subtracting the amount of image light from the detection result detected by the light detector 50. As described above, the amount of image light is superimposed on the detection result of the light detector 50. According to the display device 1 of the modified example, it is possible to change the luminance of the display panel 30 in consideration of the amount of image light radiated by the display panel 30 and to adjust the display so that the display can be easily seen by the driver.

### Second Embodiment

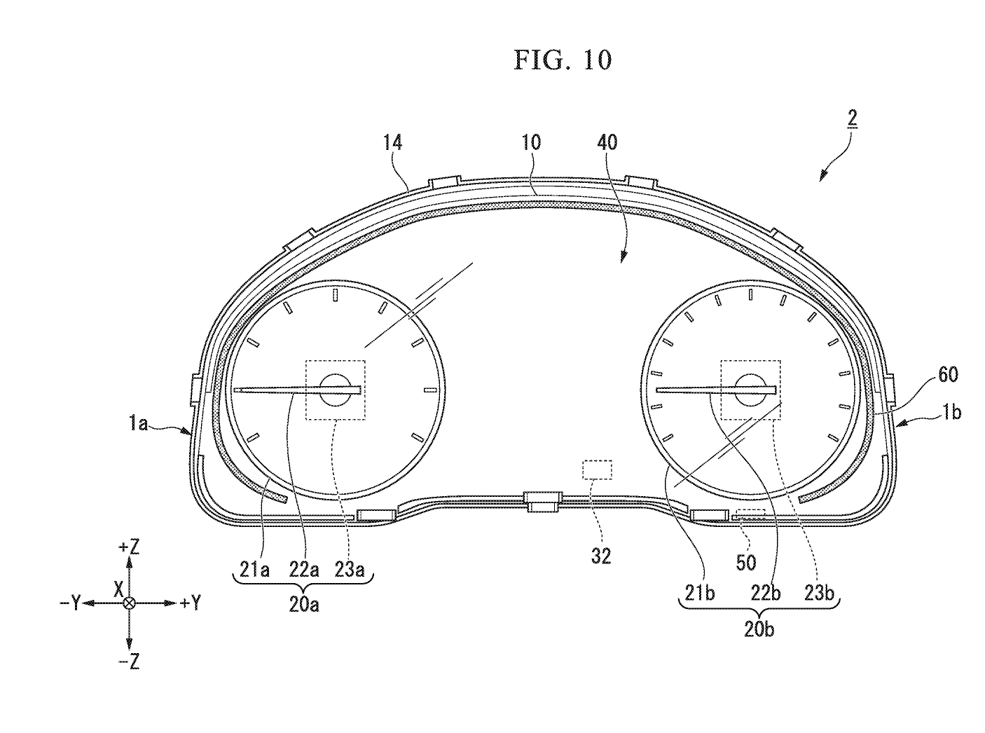

Hereinafter, a second embodiment of the present invention will be described with reference to the drawing. FIG. 10 is a front view of a display device 2 according to a second embodiment. In the first embodiment, the case in which the display device 1 includes the analog meter 20 and the display panel 30 has been described, but in the second embodiment, a case in which the display device 2 does not include the analog meter 20 and the display panel 30 but includes only the analog meter 20 will be described. Constituent elements similar to those of the above-described embodiment are designated by the same reference numerals, and descriptions thereof will be omitted.

In the example shown in FIG. 10, the display device 2 does not include the display panel 30 and includes only the analog meter 20 (an analog meter 20a and an analog meter 20b shown in the drawing). The analog meter 20a is provided on the left side as seen by the driver, and the analog meter 20b is provided on the right side as seen by the driver. The analog meter 20a includes, for example, a ring 21a, a pointing needle 22a, and a actuator 23a. The analog meter 20b includes a ring 21b, a pointing needle 22b, and a actuator 23b. Since the control in which each of the analog meter 20a and the analog meter 20b indicates the vehicle information is the same as the above-described control, the description thereof will be omitted. In the following description, when the analog meter 20a and the analog meter 20b are not distinguished from each other, they are collectively referred to as the analog meter 20. Instead of the constitution including the two analog meters 20, the display device 2 may be constituted to include one analog meter 20 or may be constituted to include two or more analog meters 20.

The display device 2 includes a controller 32 in place of the controller 31. The display device 2 includes an illuminator (hereinafter referred to as an illuminator 60) for illuminating the display of the analog meter 20. The illuminator 60 radiates light on the basis of the control of the controller 32 and illuminates the display of the analog meter 20. It is possible to further enhance the design of the display of the display device 2 by the illuminator 60 radiating the light.

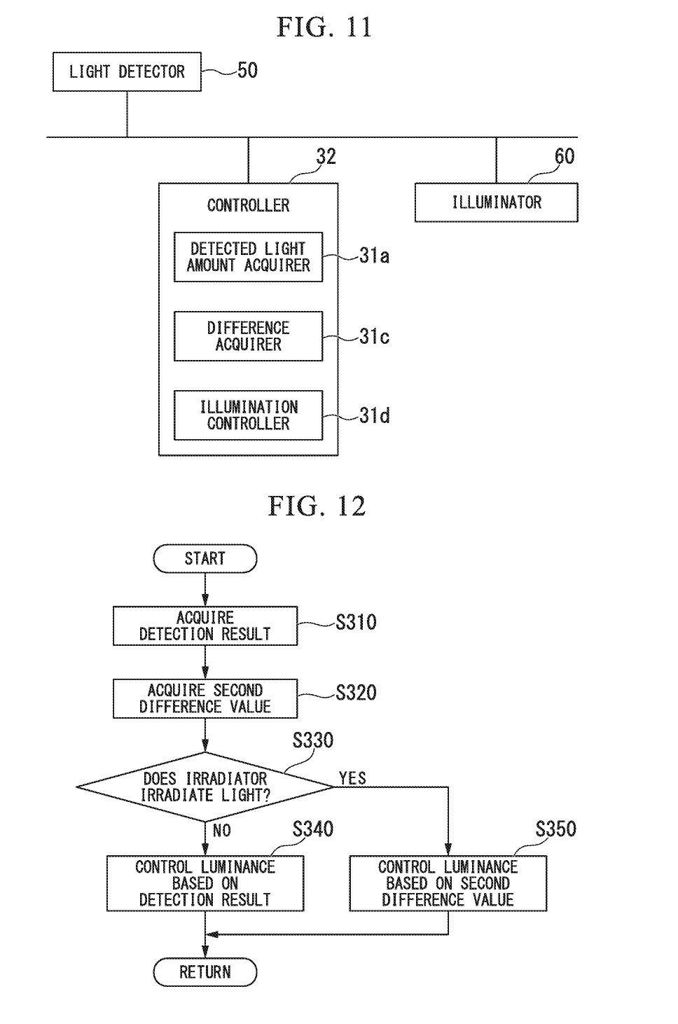

FIG. 11 is a diagram showing an example of a functional constitution of the controller 32 of the display device 2 according to the second embodiment. The controller 32, the light detector 50 and the illuminator 60 are connected via a dedicated communication line or an internal bus so that information can be transmitted and received. The controller 32 includes, for example, a detected light amount acquirer 31a, a difference controller 32c, and an illumination controller 31d as functional units thereof. The illumination controller 31d controls the illuminator 60 and radiates light. The illumination controller 31d controls the illuminator 60 to radiate light of a desired light amount, for example. The detected light amount acquirer 31a acquires information indicating the amount of light detected by the light detector 50.

Here, when the light is radiated by the illuminator 60, the amount of light radiated by the illuminator 60 is superimposed on the detection result of the light detector 50. The difference acquirer 31cacquires a value obtained by subtracting the amount of light radiated by the illuminator 60 from the detection result detected by the light detector 50. Specifically, the difference acquirer 31cacquires information indicating the detection result detected by the light detector 50 from the detected light amount acquirer 31a, acquires the information indicating the amount of light radiated by the illuminator 60 from the illumination controller 31d and then acquires a value (hereinafter referred to as a second difference value) obtained by subtracting the amount of light radiated by the illuminator 60 from the amount of light detected by the light detector 50.

When the illuminator 60 is not irradiated with light, the luminance controller 31b changes the luminance of the illuminator 60 on the basis of the detection result of the light detector 50 acquired by the detected light amount acquirer 31a and the light amount luminance correspondence information. When the illumination controller 31d irradiates the illuminator 60 with light, the illumination controller 31d changes the luminance of the illuminator 60 on the basis of the second difference value acquired by the difference acquirer 31cand the light amount luminance correspondence information.

The light amount luminance correspondence information is information in which the amount of light detected by the light detector 50 or the second difference value is associated with the luminance of the illuminator 60. Specifically, when the detection result of the light detector 50 or the second difference value indicates that the amount of light is great (that is, the surroundings of the display device 2 are bright), the light amount luminance correspondence information is associated with high luminance, and when the detection result of the light detector 50 or the second difference value indicates that the amount of light is small (that is, the surroundings of the display device 2 are dark), the light amount luminance correspondence information is associated with low luminance

Therefore, the controller 32 increases the luminance of the light radiated by the illuminator 60 when the surroundings of the display device 2 are bright and decreases the luminance of the light radiated by the illuminator 60 when the surroundings of the display device 2 are dark. The controller 31 may be constituted to control the illuminator 60 to a predetermined luminance even when the detection result of the light detector 50 indicates that light is not detected. The predetermined luminance is a luminance at which the driver is not prevented from visually recognizing the analog meter 20.

FIG. 12 is a flowchart showing an example of processing of the controller 32 according to the second embodiment. The processing of this flowchart is repeated, for example. The detected light amount acquirer 31a acquires information indicating the detection result from the light detector 50 (Step S310). The difference acquirer 31c acquires the second difference value on the basis of the amount of light detected by the light detector 50 and the amount of light radiated by the illuminator 60 (Step S320). The illumination controller 31d changes the luminance of the illuminator 60 on the basis of a control state of the illumination controller 31d (Step S330). When the illuminator 60 does not radiate light, the illumination controller 31d controls the luminance of the light radiated by the illuminator 60 on the basis of the information indicating the detection result of the light detector 50 acquired by the detected light amount acquirer 31a and the light amount luminance correspondence information (Step S340). When the illuminator 60 radiates light, the illumination controller 31d controls the luminance of the light radiated by the illuminator 60 on the basis of the second difference value acquired by the difference acquirer 31cand the light amount luminance correspondence information (Step S350).

In the above description, the case in which the illumination controller 31d controls the luminance of the light radiated by the illuminator 60 on the basis of the second difference value when the illuminator 60 radiates light has been described, but the present invention is not limited thereto. The illumination controller 31d may control the luminance of the light radiated by the illuminator 60 on the basis of the detection result of the light detector 50, regardless of whether or not the illuminator 60 radiates light.

In this case, the controller 32 may not include the difference acquirer 31c.

A lighting method in which the illuminator 60 is turned on on the basis of the control of the illumination controller 31d may be a dynamic lighting method or a static lighting method. When the illuminator 60 is turned on by the dynamic lighting method, the illuminator 60 is turned on by repeating the turning on and off to an extent that the driver constantly recognizes the light emission.

The display device may include the display panel 30 and the illuminator 60. In this case, the controller includes the detected light amount acquirer 31a, the luminance controller 31b, the difference acquirer 31c, and the illumination controller 31d, the luminance controller 31b controls the luminance of the display panel 30 on the basis of the amount of light emitted by the illuminator 60 and the image light, and the illumination controller 31d controls the luminance of the light radiated by the illuminator 60 on the basis of the amount of light radiated by the illuminator 60 and the image light.

Although the embodiment of the present invention has been described in detail with reference to the drawings, the specific configuration is not limited to this embodiment, and appropriate modifications can be made without departing from the spirit of the present invention. The constitutions described in the above embodiments may be combined.

What is claimed is:

1. A display device comprising:
a display,
a protective member which covers at least a part of the display and is formed of a member different from a display surface of the display, and
a light detector which is provided in contact with or in proximity to the protective member and is configured to detect an amount of light guided by the protective member.

2. The display device according to claim 1, wherein the display is configured to display an image recognized as a vehicle meter.

3. The display device according to claim 1, further comprising a luminance controller which is configured to change a luminance of the display on the basis of a detection result of the light detector.

4. The display device according to claim 2, further comprising a luminance controller which is configured to change a luminance of the display on the basis of a detection result of the light detector.

5. The display device according to claim 1, wherein the display is mounted together with a mechanical display mechanism.

6. The display device according to claim 1, wherein the display includes a mechanical display mechanism and is configured to display a physical quantity relating to a traveling state of a vehicle.

7. The display device according to claim 1, further comprising an illuminator which is configured to illuminate the display, and an illumination controller which is configured to change a luminance of the illuminator on the basis of a detection result of the light detector.

8. The display device according to claim 7, further comprising a difference acquirer configured to acquire a value obtained by subtracting at least one of an amount of light radiated by the display and an amount of light radiated by the illuminator from the detection result detected by the light detector as an amount of external light.

9. The display device according to claim 1, wherein the protective member has a structure in which a surface portion covering at least a part of a display surface of the display and an extending portion extending from an outer edge of the surface portion and attached to a support member are integrally formed, and
the light detector is provided in contact with or in proximity to the extending portion.

10. The display device according to claim 1, wherein the light detector is provided at a lower end of the protective member.

11. A mounting structure of a vehicle meter, wherein a protection member formed of a member different from a display surface of a display configured to display an image recognized as a vehicle meter is mounted to a support member to cover at least a part of the display, and
a light detector configured to detect an amount of light guided by the protective member is provided in contact with or in proximity to a lower end of the protective member.
